(19) United States
(12) Patent Application Publication
(10) Pub. No.: US 2015/0254651 A1
(43) Pub. Date: Sep. 10, 2015

(54) OPTIMIZING FINANCIAL TRANSACTIONS NETWORK FLOW

(71) Applicant: VODAFONE IP LICENSING LIMITED, LONDON (GB)

(72) Inventors: Oleksiy Ignatyev, Belmont, CA (US); Kevin Scarr, London (GB); Volkmar Scharf-Katz, San Francisco, CA (US)

(73) Assignee: VODAFONE IP LICENSING LIMITED, LONDON (GB)

(21) Appl. No.: 14/245,440

(22) Filed: Apr. 4, 2014

Related U.S. Application Data
(60) Provisional application No. 61/948,382, filed on Mar. 5, 2014.

(51) Int. Cl. G06Q 20/38; G06Q 20/08

(52) U.S. Cl. CPC G06Q 20/38; G06Q 20/08

(57) ABSTRACT

A method of redirecting financial transactions between users of a financial transactions network is disclosed. The method includes determining financial transaction pathways between users of a financial transactions network, where the financial transaction pathways are indicative of one or more financial transactions between the users. The method also includes applying one or more edge weights to each pathway and calculating a centrality value for each user based on the one or more edge weights. The method further includes providing information to a first user of the financial transactions network that is configured to induce the first user to redirect at least a part of one financial transaction from a second user to a third user, when the third user has a higher centrality value than the second user.

### CROSS-REFERENCE TO RELATED APPLICATIONS

This application is a non-provisional of, and claims priority to and the benefit of, U.S. Patent Application Ser. No. 61/948,382 filed on Mar. 5, 2014 and entitled “OPTIMIZING FINANCIAL TRANSACTIONS NETWORK FLOW,” which application is hereby expressly incorporated herein by this reference in its entirety.

### BACKGROUND OF THE INVENTION

1. The Field of the Invention

The present invention relates to communication systems and financial transactions networks. More specifically, the present invention relates to methods, systems, and apparatuses that determine and adapt money flow in financial transactions networks.

2. The Relevant Technology

Unless otherwise indicated herein, the materials described in this section are not prior art to the claims in this application and are not admitted to be prior art by inclusion in this section. The use of the term “background” is inclusive of the term “context.” Thus, the following section provides both context for the disclosure and may also provide patentable support for the claims.

The use of electronic financial transaction networks continues to grow as more and more people chose such networks to perform financial transactions such as buying a good or a service. This is especially true in the last few years with the widespread use of smart phones, which make accessing an electronic financial transaction network very easy.

For one user to electronically transfer money to another user, different forms of financial transactions and communication networks may be used. Examples include, but are not limited to, debit/credit cards payment transactions networks, PayPal™ services network, applications similar to Square™ network, other mobile payment applications networks and financial transactions delivered by using special messaging used in telecommunication networks (for example M-Pesa™ services provided in Kenya by Safaricom™).

Shareholders of financial transactions networks usually are interested in their customers spending more money within their financial transactions networks. This will typically mean more revenue for the shareholders, since owners of financial transaction network take a portion from each financial transaction serviced within the network. Accordingly, shareholders of the financial transactions networks are interested in ways to ensure that more transactions occur within their networks to thereby increase revenue.

### BRIEF DESCRIPTION OF THE DRAWINGS

Various embodiments of the present invention will now be discussed with reference to the appended drawings. It is appreciated that these drawings depict only typical embodiments of the invention and are therefore not to be considered limiting of its scope. In the drawings, like numerals designate like elements. Furthermore, multiple instances of an element may each include separate letters appended to the element number. For example two instances of a particular element “20” may be labeled as “20a” and “20b”. In that case, the element label may be used without an appended letter (e.g., “20”) to generally refer to every instance of the element; while the element label will include an appended letter (e.g., “20a”) to refer to a specific instance of the element.

FIG. 1 illustrates an exemplary computing system on which principles described herein may be employed;

FIG. 2 illustrates an exemplary financial transaction network environment in which principles described herein may be employed;

FIG. 3A illustrates a graphical representation of financial transactions graph showing financial transaction pathways between five users, generated according to one embodiment;

FIG. 3B illustrates a graphical representation of a financial transactions graph showing financial transaction pathways between five users, generated according to another embodiment;

FIG. 3C illustrates a graphical representation of a financial transactions graph showing financial transaction pathways between five users, generated according to a further embodiment;

FIG. 4 illustrates a method of determining one type of centrality value for each user according to one embodiment;

FIG. 5 illustrates a method of entering information into a financial transactions network to redirect transactions in the network according to one embodiment;

FIGS. 6A-6c illustrate mobile payments in a financial transactions network according to another embodiment;

FIGS. 7A-7C illustrate locating a file within a network of file providers according to one embodiment; and

FIG. 8 illustrates a method for identifying an alternative user who a first user can redirect money flow during a future financial transaction according to one embodiment.

### DETAILED DESCRIPTION

In the following detailed description, reference is made to the accompanying drawings, which form a part hereof. In the drawings, similar symbols typically identify similar components, unless context dictates otherwise. The embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the figures, can be arranged, substituted, combined, separated, and designed in a wide variety of different configurations, all of which are explicitly contemplated herein. It will also be understood that any reference to a first, second, etc. element in the claims or in the detailed description, is not meant to imply numerical sequence, but is meant to distinguish one element from another unless explicitly noted as implying numerical sequence. In addition, as used in the specification and appended claims, directional terms, such as “top,” “bottom,” “up,” “down,” “upper,” “lower,” “proximal,” “distal,” “horizontal,” “vertical,” and the like are used herein solely to indicate relative directions and are not otherwise intended to limit the scope of the invention or claims.

The present invention relates to communication systems and financial transactions networks. More specifically, the present invention relates to methods, systems, and apparatuses that determine and adapt money flow in financial transactions networks.

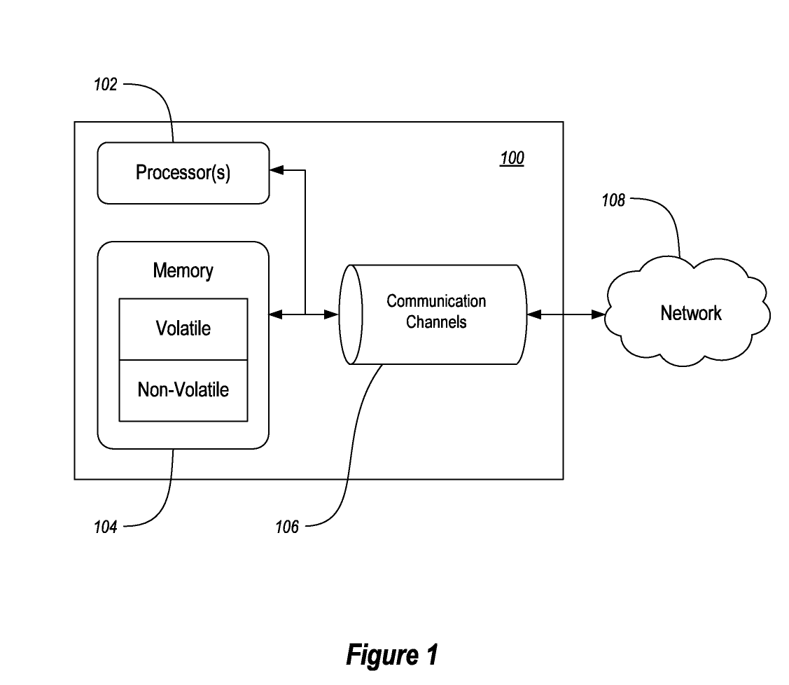

Some introductory discussion regarding general computing systems and computing environments in or on which the principles described herein may be employed will now be described with reference to FIG. 1.

Computing systems are now increasingly taking a wide variety of forms. Computing systems may, for example, be handheld devices, appliances, laptop computers, desktop computers, mainframes, distributed computing systems, or even devices that have not conventionally been considered a computing system. In this description and in the claims, the term “computing system” is defined broadly as including any device or system (or combination thereof) that includes at least one physical and tangible processor, and a physical and tangible memory capable of having stored thereon computer-executable instructions that may be executed by the processor(s). The memory may take any form and may depend on the nature and form of the computing system. A computing system may be distributed over a network environment and may include multiple constituent computing systems.

Embodiments described herein may comprise or utilize a special purpose or general-purpose computer including computer hardware, such as, for example, one or more processors and system memory. For example, FIG. 1 illustrates an exemplary computing system 100. As illustrated in FIG. 1, in its most basic configuration, computing system 100 typically includes at least one processing unit 102 and memory 104. The memory 104 may be physical system memory, which may be volatile, non-volatile, or some combination of the two. The term “memory” may also be used herein to refer to non-volatile mass storage such as physical storage media. If the computing system 100 is distributed, the processing, memory and/or storage capability may be distributed as well. As used herein, the term “module” or “component” can refer to software objects or routines that execute on the computing system 100. The different components, modules, engines, and services described herein may be implemented as objects or processes that execute on the computing system 100 (e.g., as separate threads).

In the description that follows, embodiments are described with reference to acts that are performed by one or more computing systems, such as the computing system 100. If such acts are implemented in software, one or more processors of the associated computing system that performs the acts direct the operation of the computing system in response to having executed computer-executable instructions. An example of such an operation involves the manipulation of data. Within the context of the computing system 100, computer-executable instructions (and the manipulated data) may be stored in the memory 104. Computing system 100 may also contain communication channels 106 that allow the computing system 100 to communicate with other message processors over, for example, network 108.

Embodiments described herein also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes recordable-type storage media, such as RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network (e.g., the network 108) and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a Network Interface Controller (NIC)), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at a processor, cause a general purpose computer, special purpose computer, or special purpose processing device to perform a certain function or group of functions. The computer executable instructions may be, for example, binaries, intermediate format instructions such as assembly language, or even source code. Although the subject matter is described herein using language specific to structural features and/or methodological acts, it is to be understood that the subject matter defined in the appended claims is not necessarily limited to the described features or acts described herein. Rather, the features and acts described herein are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

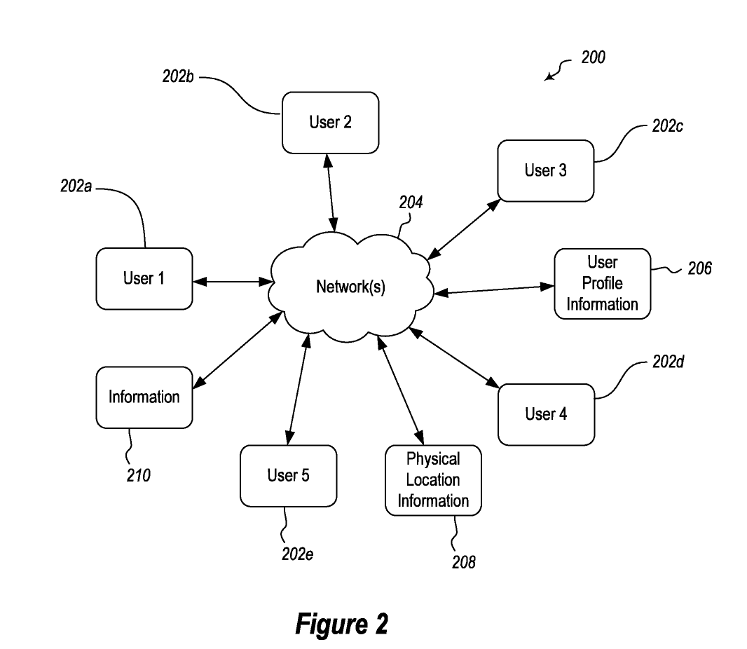

FIG. 2 illustrates an exemplary environment 200 in which the embodiments described herein may be employed. The environment includes multiple users 202 (202a-202e) that electronically transfer money to each other to complete some type of electronic financial transaction using one or more electronic financial transactions networks 204. The types of financial transactions may include the purchase of goods and services for which the money is transferred to pay for the purchase or it may include a transfer of money as a refund for a returned or voided purchase. One of skill in the art will appreciate that the financial transaction may include any transaction that requires the transfer of money, goods, or services. It will also be appreciated that the term “money” is to be interpreted broadly to include anything of value that may be transferred from one party to another as part of a financial transaction.

Each user 202 can be an individual, an organization, a business or other entity, or any other type of group. In addition, there may be multiple layers of users. For example, on a first layer a user may be a business entity, and on a second layer a user may be an employee of the business entity. As such, there may be multiple users of one layer associated with a single user in another layer. It will be appreciated that some financial transactions networks 204 may include some users that are individuals and some that are business entities. Accordingly, use of the term “user” in the description and the claims is intended to cover all types of potential users as the context of the description implies. Although only five users 202 are illustrated, it will be appreciated that a virtually unlimited number of users, within practical limits, can be incorporated within embodiments disclosed herein; only five users are being illustrated for ease of discussion.

The environment 200 also includes user profile information 206 about the users 202. The user profile information 206 may be stored in a database that is part of the financial transactions networks 204 or it may be stored in a database that is separate from the financial transactions network 204. The user profile information 206 may include information about characteristics of the users 202 such as what type of entity they are. For example, the users 202 may be an individual, organization, or business or other entity that primarily uses the financial transactions network 204 to purchase goods or services by transferring money to a seller. Alternatively, the users 202 may be a vendor or seller of goods or services that primarily use the network 204 to receive money from a buyer of the goods or services. The user 202 may also be an agent of the financial transaction network 204. It will be appreciated that the user profile information 206 may include any information about the users. The information 210 may also include information about characteristics of financial transactions a user is involved with such as spending habits, types of products purchased or sold, favorite products, and the like. This information may be beneficial to the owners of the financial transactions network 204. This information may be filtered as needed as will be described in more detail to follow.

The environment 200 also includes physical location information 208 about the users 202. The physical location information 208 may be stored in a database that is part of the financial transactions networks 204 or it may be stored in a database that is separate from the financial transactions network 204. The physical location information 208 may be used to determine the actual physical location of the various users 202.

The environment 200 may also include information 210 that is intended to cause a redirection of financial transactions in the financial transactions network 204. The information 210 may be stored in a database that is part of the financial transactions networks 204 or it may be stored in a database that is separate from the financial transactions network 204. The information 210 may be provided to one or more users 202 to cause the user to redirect one or more financial transactions in the network as will be described in more detail. The information 210 may be any type of information that is intended to cause or induce the redirection of the transaction such as, but not limited to, any type of advertisement, a coupon offering a percent off the cost of the future transaction, a push promotion, or a recommendation from other users of the financial transactions network.

For one user 202 to electronically transfer money to another user 202, different forms of financial transactions networks 204 may be used. Examples include, but are not limited to, debit/credit cards payment transaction networks, PayPal™ services network or networks that function in a manner similar to PayPal™, applications similar to Square™ network, other mobile payment application networks and financial transactions delivered by using special messaging used in telecommunication networks (for example M-Pesa™ services provided in Kenya by Safaricom™).

Many of these forms of financial transactions were only made possible a few years ago. It is likely, therefore, that even more forms of financial transactions not known today will be used in the future. Those forms of financial transactions are also envisioned by the concepts of the present application and embodiments of the invention disclosed herein can incorporate those unknown forms of financial transactions when the unknown forms become available.

Many users 202 avail themselves of more than one of the available forms of electronic financial transactions. For example, many users 202 make credit card financial transactions or use PayPal™ financial transactions services. In addition, most of today's “smart phones” and tablets utilize special software and/or hardware applications running on those devices that include the ability to make financial transactions over the Internet through a mobile network, thereby allowing owners of these devices to avail themselves of those additional forms of financial transactions.

The owners of a financial transactions network 204 are typically interested in having their customers (i.e., the users 202 who use the financial transactions network 204) spend more money within their specific financial transactions network 204. Having the users 202 spend more money within the financial transactions network 204 will generally mean more revenue for the owners of the network. In particular, the owners of a financial transactions network 204 may be interested in the occurrence of financial transactions which can cause a “chain reaction” of additional financial transactions in the network following the initial financial transaction. Accordingly, it may be useful to the owners of a financial transactions network 204 to redirect some future potential financial transactions within their financial transactions network 204 in order to increase the overall amount of money (for example, electronic funds) and/or the number of financial transactions transferred within the financial transactions network. It will be appreciated that increasing the amount of money transferred in the financial transaction network will lead to increased revenue to the owners of the financial transactions network 204.

The embodiments disclosed herein may be used to help the owners of the financial transactions networks 204 leverage knowledge of what influences transactions in financial services networks. That is, using the embodiments disclosed herein, money flow in financial transactions networks may be optimized for more efficient flow. Using this information, the owners of the financial transactions networks 204 may determine the best manner for introducing information to different users 202 involved into a network that will result in some of the future financial transactions being redirected. In addition, financial transactions network 204 may be adapted with regards to the introduced information to thereby lead to more efficient money flow within the adapted financial transactions network and more revenue for the owners.

Embodiments disclosed herein use the principles of graph theory to obtain such information. Graph theory is the study of graphs, which are mathematical structures used to model pairwise relations between objects from a collection, such as a network. A “graph” in this context is a collection of “vertices” or “nodes” and a collection of “edges” or “arcs” that connect pairs of vertices. Vertices are said to be adjacent if they are connected by an edge.

A graph may be undirected, meaning that there is no distinction between the two vertices associated with each edge, or its edges may be directed from one vertex to another. In mathematical terms, a graph for a network comprising a set of vertices V and a set of edges E is represented as G(V,E). As such, the term “graphs” in graph theory refer to networks rather than visual charts. This graph representation provides a way to capture and quantify connections between vertices.

Embodiments disclosed herein incorporate principles of graph theory to analyze money flow through a financial transactions network such as a financial transaction network 204 and to determine effective manners to provide appropriate information to some users 202 involved in the financial transactions network so that the information can cause an efficient redirection of some of financial transactions and therefore cause an adaptation of a financial transactions network. For example, using graph theory, the concept of centrality is used in embodiments disclosed herein to determine the relative importance of each of the vertices of a financial transactions network graph to aid in determining efficient money flow. Depending on how it is measured, the centrality values of the vertices can indicate relative influence of the vertex, relative throughput of money, etc. The vertices can represent users 202 in a network, or any other type of node through which money can flow. In other words, the users 202 when discussed herein in relation to a graph represent vertices or nodes of the graph.

Although graphs refer to networks in graph theory, graphs can be represented graphically by drawing a dot or circle for every vertex, and drawing a line or an arc between two vertices if they are connected by an edge. If the graph is directed, the direction of the line or arc is indicated by drawing an arrow.

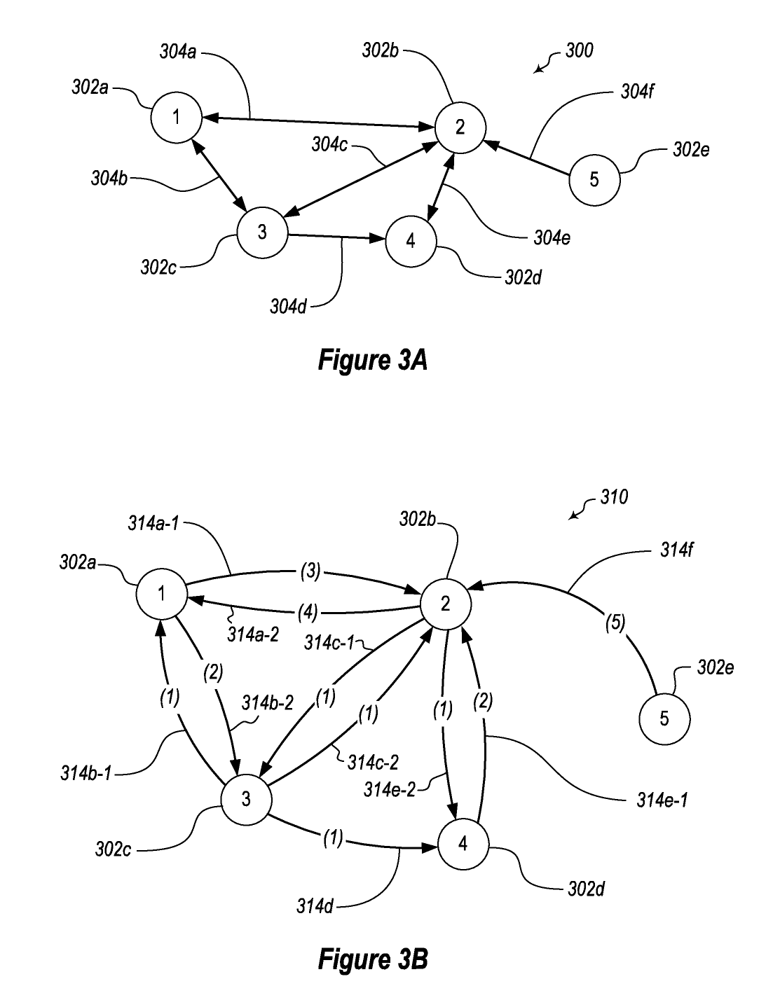

For example, FIG. 3A is a graphical representation of a financial transactions graph 300 representing financial transactions, or at least a part of a financial transaction, made between users 202 in a particular time period in an exemplary financial transactions network 204, according to sample data shown in Table 1, below, where each arrow (→) represents the direction of the associated transaction (e.g., “User 1→User 2” signifies that User 1 transferred money to User 2). As noted above, only five users are being represented in the exemplary network for ease of discussion; many more than five users would likely be found in networks and systems that can employ the methods discussed herein.

TABLE 1

| | Number of Financial |
|---|---|
| Users involved | Transactions Made |
| User 1 → User 2 | 3 |
| User 1 → User 3 | 2 |
| User 1 → User 4 | 0 |
| User 2 → User 1 | 4 |
| User 2 → User 3 | 1 |
| User 2 → User 4 | 1 |
| User 3 → User 1 | 1 |
| User 3 → User 2 | 1 |
| User 3 → User 4 | 1 |
| User 4 → User 1 | 0 |
| User 4 → User 2 | 2 |
| User 4 → User 3 | 0 |
| User 4 → User 5 | 0 |
| User 5 → User 2 | 5 |
| User 5 → User 4 | 0 |

Financial transactions graph 300 has five vertices 302 (302a-302e), which respectively represent the five users 202. A number of edges 304 (304a-304f) are also included which represent financial transactions pathways used between the users 202 during the time period, based on the sample data. The arrows on financial transactions pathways 304 indicate the direction of financial transactions made using the pathways, with bidirectional arrows indicating that financial transactions were initiated by both parties during the time frame. Although only five users are represented in financial transactions graph 300, it will be appreciated that virtually any number of users can be represented, if desired. As noted above, five users have been selected herein solely to simplify the discussion.

The following information can be ascertained from financial transactions graph 300. During the selected time period, financial transactions pathways were used between the following pairs of users: 1-2, 1-3, 2-3, 2-4, 2-5, and 3-4. Thus, those pairs are said to be adjacent pairs. Furthermore, financial transactions graph 300 tells us that user 1 initiated at least one financial transaction to each of users 2 and 3 and received at least one financial transaction from each of users 2 and 3; user 2 initiated at least one financial transaction to each of users 1, 3, and 4 and received at least one financial transaction from each of users 1, 3, 4, and 5; user 3 initiated at least one financial transaction to each of users 1, 2, and 4 and received at least one financial transaction from each of users 1 and 2; user 4 initiated at least one financial transaction to user 2 and received at least one financial transaction from each of users 2 and 3; and user 5 initiated at least one financial transaction to user 2 but did not receive any financial transactions.

Using the information obtained from financial transactions graph 300, some valuable system information regarding financial transactions network 204 can be determined. For example, from graph 300, we learn that user 2 had financial transactions with the most other users (4) while user 5 had financial transactions with the fewest (1).

Although financial transactions graph 300 gives some useful information about the financial transactions pathways used between users 1-5 during the time period, the information from financial transactions graph 300 may yield an incomplete picture. For example, while each of the pathways 304 of financial transactions graph 300 may indicate which user pairs had one or more financial transactions between them, the pathways 304 do not indicate any other information regarding the financial transactions, such as total amount of money transferred between the users, timestamps of financial transaction, frequency at which financial transactions occurred, etc. In other words, the financial transactions pathways do not give any information regarding the relative strength of the pathways between adjacent users 202. For example, user 5's one financial transaction may have transferred $100 while each of user 2's four transactions may have only transferred $1 each. Thus, even though user 5 has less financial transactions than user 2, user 5's financial transaction was of greater value to the financial transaction network.

To take into account this type of information, a graph structure can be extended by assigning a weight to each edge of the graph. Graphs with edge weights, or weighted graphs, are used to represent structures in which pairwise connections have some numerical values. A higher weight for an edge generally signifies a stronger relationship between the two adjacent vertices. The edge weight can be determined based on any measure that yields a relative strength of the edge with respect to the other edges in the graph. For example, a higher edge weight can reflects more financial transactions made between the adjacent users and/or total amount of money transferred between the users and/or higher frequency of transactions occurred between the users, and thus represents a stronger relative connection.

FIG. 3B is a graphical representation of a financial transactions graph 310 of the network 204 in which the edge lines 304 of financial transactions graph 300 have been replaced with edge arcs 314. Each edge arc 314 represents financial transactions pathways that occurred between users 202 in a particular direction. In the embodiment shown, the pathways again represent the information disclosed in Table 1, above. Each edge line in financial transactions graph 300, (e.g., edge line 314a of FIG. 3A) has been replaced in financial transactions graph 310 with a pair of edge arcs 314, one for each direction (e.g., edge arcs 314a-1 and 314a-2).

Each edge arc 314 also includes a weight, shown in parentheses. For example, the weights of edge arcs 314a-1 and 314a-2 are three and four, respectively. For this embodiment, each of the edge weights represents the number of financial transactions made in the particular direction between the adjacent users using the particular pathway or the amount of money transferred between the adjacent users. Thus, a higher edge weight reflects more financial transactions made or more money transferred between the adjacent users and thus represents a stronger relative connection. As such, in addition to the information obtainable from financial transactions graph 300, financial transactions graph 310 can also be used to determine the strength of the financial transactions relationship between any two users of system 204.

For example, using financial transactions graph 310 of FIG. 3B, one can determine that user 1 initiated three financial transactions with user 2 and initiated two financial transactions with user 3, and received financial transactions from user 2 and one financial transaction from user 3. Similar determinations can be made regarding the rest of the users 202. This gives a more accurate picture than graph 300 regarding the strength of the interactions between users 1-5 of network 204 during the time period.

For example, using only financial transactions graph 300, it appears that user 5 has the least amount of financial transactions during the time period because user 5 has only one financial transactions pathway in financial transactions graph 300. However, financial transactions graph 310 reveals that while user 5 only had financial transactions with one other user (user 2), user 5 had five financial transactions with that one other user, which is just one financial transaction fewer than user 2, which made the most financial transactions during the time period. Thus, the financial transactions pathway from user 5 to user 2 is strong relative to the other financial transactions pathways in network 204.

As noted above, although physical graphs can be used to show data used in graph theory, the physical graphs are not the “graphs” identified in graph theory; the term “graphs” refer to networks rather than visual charts. That is, the “graphs” of graph theory are mathematical structures. These mathematical structures can be represented in many ways, only one of which is physical graphs. Other types of data structures can also be used that correlate the data between the particular vertices. For example, the data corresponding to network 204 can be stored in structured tables in one or more databases. Other types of data structures that correlate the information with respect to the particular users (graph vertices) and corresponding pathways (graph edges) of network 204 can also be used, as is known by one skilled in the art of graph theory.

In addition, although financial transactions graphs 300 and 310 represent past usage of network 204, it will be appreciated that financial transactions graphs 300 and 310 can be used in a real-time fashion to represent past and/or current financial transactions of network 204. That is, each graph can be updated in real-time to reflect financial transactions as it occurs on the network.

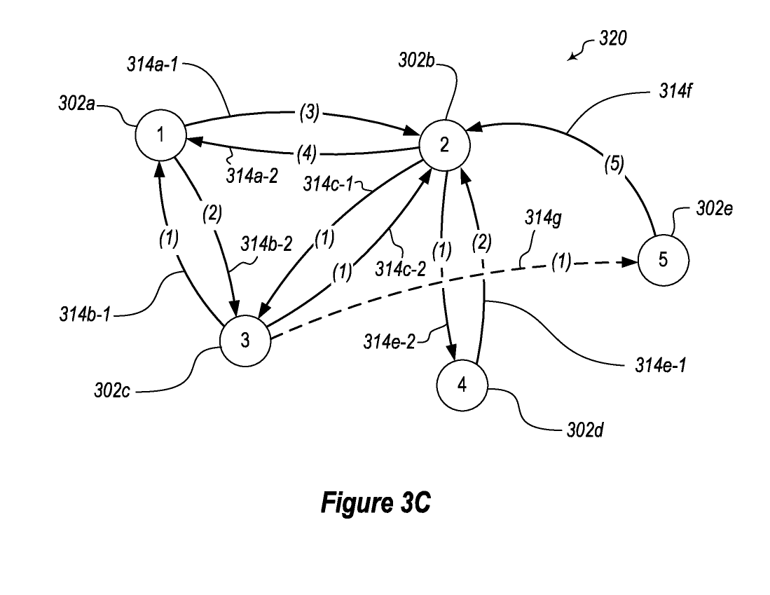

FIG. 4 discloses one method of determining a centrality value for each user in a given network. As with the discussion above, values from an exemplary financial transaction network 204 will be used and reference will be made to the graphs shown in FIGS. 3A and 3B to aid in the discussion. However, the financial transaction network 204 and the corresponding graphs in FIGS. 3A and 3B are examples only and not to be limiting of the methods discussed herein.

In step 402, financial transactions pathways between users are determined. To do so, a desired time period for the financial transactions graph is first selected. For example, the desired time period can be any time period measured in seconds, minutes, hours, days, months or even years. The time period can be contiguous or non-contiguous (i.e., comprised of multiple sub-time periods). An example of a contiguous time period is two months (e.g., all financial transactions made in the past two months). An example of a non-contiguous time period is a particular sub time-period each day for a particular amount of time (e.g., all financial transactions made between 6 pm and 9 pm on every weekday evening for the past two months). Of course, the above are only examples of time periods that can be used; any other contiguous or non-contiguous time period can also be used.

Once the time period has been selected, all financial transactions pathways between users during that time period are determined, as discussed above. A graph can then be generated using the vertices to represent the users and the edges to represent the financial transactions pathways, as shown in FIG. 3A. The number of vertices (i.e., users) in the financial transactions graph can vary, depending on the size of the network, the information desired, the selected time period, etc. For our exemplary network, financial transactions pathways between each of 5 users determined in a step for a particular time period yielded the financial transactions graph 300 shown in FIG. 3A, as discussed above.

In some embodiments, an external data source may supplement the user objects (vertices) and allow for any combination of attributes to be filtered out from view to thus remove various users 202 from the graph or at least to ensure that these users are not part of the centrality value calculation as described. For example, the user profile information 206 may be accessed to ascertain information about users 202. In one embodiment, the user profile information 206 may provide a list of users 202 who are M-Pesa™ agents or merchants, and the graph could be filtered to remove all other agents so their transactions do not contribute to any results. In this way, the generated graph is able to only include such user profile information as is desired by the owner of the financial transaction network 204.

In some embodiments, an additional edge filter may be applied to the graph to filter by geographic location of the originator of the financial transaction and/or recipient of the financial transaction. For example, investigating only transactions that originate and terminate in a named geographic region or province (or other spatial defined region). The physical location information 208 may be used to provide this information and to provide the filtering as needed. In this way, the generated financial transactions graph is able to only include such user geographic information as is desired by the owner of the financial transaction network 204.

In step 404, edge weight factors can be selected for the financial transactions pathways to accurately reflect relative strengths of the financial transactions pathways with respect to each other. By way of example, and not limitation, some factors that can be used to determine the weight for each edge with respect to financial transactions can include: the number of financial transactions between users, the amount of money transferred by the transactions, the time of day the transactions were made, the day of the week the transactions were made, the amount of time that elapsed before another transaction was made by the same user, and frequency of transactions between users. In addition, the factors that can be used to determine the weight for each edge with respect to financial transactions can also include geographic attributes such as distance between parties through to ratios of transactions leaving a financial ecosystem of interest, e.g., % transactions where funds removed from financial system/fund withdrawal. It will be appreciated that other factors may also be used to determine the weight of each edge.

In step 406, once the edge weight factors have been selected, weights can be assigned to each edge weight factor based on the relative value of the edge weight factors with respect to each other. For example, if two edge weight factors are selected (e.g., the number of transactions and the amount of money transferred between the users) and it is determined that both edge weight factors equally impact the edge, then both factors can be assigned the same weight, e.g., 50% & 50%. In addition, one or more of the weights can be variable or represented in a formula.

In step 408, the weighted edge weight factors can be applied to each financial transaction pathway in the graph. This allows the financial transaction pathways in the graph to each receive a numerical value that can be compared with the other financial transaction pathways in the financial transactions graph.

In step 410, once the edge weight factors have been applied to each financial transaction pathway so as to assign a numerical value to the financial transaction pathway, a centrality value can be determined for each user 202. Generally, a higher centrality of a vertex in a graph signifies a greater measure of importance and reach. Also we may calculate an inwards and outwards centrality for each vertex separately, where an inwards centrality corresponds to the financial transactions initiated by the user (vertex), and an outwards centrality corresponds to the financial transactions received by the user (vertex). Also we may calculate centrality for each vertex as a function of inwards and outwards centrality values of the vertex. For example, centrality of the vertex may be computed as a proportion of funds received by the vertex within last hour/day/week/month and paid or transferred later further to other vertices of the network within next hour/day/week/month.

If a less-accurate centrality value is all that is needed, the centrality value CV for each user 202 can be determined without using edge weights. In one embodiment, the centrality value of a user can be equated to the number of adjacent users corresponding to the particular user (i.e., the number of users with which the particular user has had financial transactions). For example, using graph 300, the centrality value of each user 202 in the financial transaction network 204 is reflected in Table 2, below, according to this manner of centrality derivation.

TABLE 2

| User | CV |
|---|---|
| User 1 | 2 |
| User 2 | 4 |
| User 3 | 3 |
| User 4 | 2 |
| User 5 | 1 |

As can be seen in Table 2, user 2 has the highest centrality value when using this manner of centrality derivation. In some embodiments, this can signify that user 2 has more importance and/or reach, signifying that electronic money that flows through user 2 may spread more quickly through the network and to/from more users. This can help to more efficiently enter electronic money into the network.

For the example of centrality values above, inwards centrality values of all users (using graph 300) can be calculated as:

TABLE 2A

| User | Inwards CV |
|---|---|
| User 1 | 2 |
| User 2 | 4 |
| User 3 | 2 |
| User 4 | 2 |
| User 5 | 0 |

and outwards centrality values of all users (using graph 300) can be calculated as:

TABLE 2B

| User | Outwards CV |
|---|---|
| User 1 | 2 |
| User 2 | 3 |
| User 3 | 3 |
| User 4 | 1 |
| User 5 | 1 |

For example, because user 2 has a greater outwards centrality value than user 1, we may assume that it is more likely that user 2 transfers money to other users than user 1 does. Therefore, having this knowledge/assumption available, the owners of a financial transaction network 204 would like to redirect a current (or potential future) financial transaction of user 3 to user 1 to a financial transaction of user 3 to user 2. This is because it is more likely that user 2 would then transfer the money to other users of the financial transactions network 204. As will be appreciated, the owners of the financial transactions network 204 are interested in having the greatest number of transactions that keep money with the network as possible as this increases the owner's profits.

Redirecting the transaction would adapt/modify the initial financial transactions network 204. Accordingly, to achieve redirection of potential future financial transactions of user 3 to user 1 to a transaction of user 3 to user 2, in Step 412 information such as information 210 may be entered to the network 204 that would inform user 3 about the potential benefits of making financial transactions with user 2 instead of user 1 and thus cause user 3 to redirect a transaction. It will be appreciated that the information provided to user 3 may be any type of information 210 such as, but not limited to, any type of advertisement, a coupon offering a percent off the cost of the future transaction, a push promotion, a recommendation from other users of the financial transactions network who have had a transaction with the user 2, or perhaps a free sample of the service provided by user 2.

For instance, if users 1 and 2 provide the same services to the customers on the market, than the redirection may make sense to user 3 if the prices (or location) of user 2 are better than corresponding prices (or location) of user 1. This is especially relevant for groups of users that are looking to re-invest money back into their local community (i.e., supporting the local community) and to promote purchases from local producers.

In many cases the above manner of centrality derivation is not accurate enough because it does not take into account the relative strength of the financial transaction pathways. Therefore, in other embodiments, the centrality value CV is determined while taking into account the weighted values of the financial transaction pathway arcs 314.

In one embodiment, the centrality value of a user 202 can be equal to the non-decreasing with respect to all its variables function of number of adjacent vertices and weights of all of the financial transaction pathways associated with the user. For example, the centrality value can be equated to the sum of the weights of all of the financial transaction pathways associated with the user. For instance, user 1 initiated three financial transactions to user 2 and two financial transactions to user 3 during the particular time period and received four financial transactions from user 2 and one financial transaction from user 3. Thus, the weighted financial transactions pathway values corresponding to user 1 are 3, 2, 4, and 1. Summing the weighted values (3+2+4+1) yields a centrality value for user 1 of 10. The weighted centrality value, weighted inwards centrality value, and weighted outwards centrality value of each user in the financial transactions network 204 is reflected in Tables 3, 3A, and 3B below, according to this manner of centrality derivation.

TABLE 3

| User | CV |
|---|---|
| User 1 | 10 |
| User 2 | 17 |
| User 3 | 6 |
| User 4 | 4 |
| User 5 | 5 |

TABLE 3A

| User | Inwards CV |
|---|---|
| User 1 | 5 |
| User 2 | 11 |
| User 3 | 3 |
| User 4 | 2 |
| User 5 | 0 |

TABLE 3B

| User | Outwards CV |
|---|---|
| User 1 | 5 |
| User 2 | 6 |
| User 3 | 3 |
| User 4 | 2 |
| User 5 | 5 |

The outwards centrality approach may be especially useful when determining how to disseminate electronic money because the outgoing financial transactions pathways may more accurately reflect the relative strengths of the users in passing money on to other users. Based on the knowledge of outward centrality, one may assume that it is more likely that user 2 would initiate a financial transaction with other users than user 3 would do. Based on this knowledge, owners of a financial transactions network 204 would appreciate if future financial transactions from user 1 to user 3 could be redirected to transactions from user 1 to user 2. This redirection of future transactions could be achieved by introducing appropriate information (like advertisements) to the user 1 and, in some use cases to user 2 as well. This redirection of future transactions would cause the financial transactions network to adapt with regard to introduced information (like an advertisement) to the network users.

In another embodiment, we might consider centrality values of the users as a function of both inwards and outwards centrality values. For example, we might set a higher centrality value for a user A who received N financial transaction, and initiated K₁ financial transactions, than for a user B who received N financial transaction, and initiated K₂ financial transactions, where K₁>K₂. The logic here is that we consider user A more valuable because he/she passes more received money/transactions to other users than user B does. Therefore, for example, we can define the centrality value of a user as a difference of his outwards centrality value and inwards centrality value. Note, that in this example the centrality value could be positive or negative. But a higher centrality value still indicates more valuable user for efficient money flow in the network. Accordingly, centrality values determined by the above manners can be used to help determine efficient money flow through the network.

For all of the centrality values definitions/calculations, centrality values may be calculated without distinguishing between inwards vs. outwards transactions. Alternatively, centrality values may be determined by calculating separately corresponding inwards and/or outward centrality values of the users, and if appropriate, defining centrality of the user as a function derived from his/her inwards and/or outwards centrality values.

In some embodiments, the centrality value CV for each user can also take into account the importance of the other users to which the user is connected. In this approach, connections to high-scoring users contribute more to the value than connections to low-scoring users. In one embodiment, the hub centrality value for all (let us say we have n users total) users can be equated to an eigenvector x corresponding to the largest eigenvalue in the formula:

(A*A^{T})x=λx (eq. 1)

where x=(x₁, . . . , xₙ), and xᵢ is a centrality value CV of i^{th} user (i=1, . . . n); T represents transpose operator; A represents an n by n adjacency matrix, which can be calculated for both binary and non-binary cases. For binary case we have simply Aᵢⱼ=1 if during predefined time period there was at least one financial transaction from user i to user j, and Aᵢⱼ=0 otherwise. For non-binary case we could have Aᵢⱼ=p if, for example, during predefined time period there were p financial transactions from user i to user j (or total amount of money transferred, etc), and Aᵢⱼ=0 otherwise. In general parameter p could be a function of all financial transactions and their attributes from user i to user j.

In other embodiment, the authority centrality value for all users can be equated to the eigenvector y corresponding to the largest eigenvalue in the formula

(A^{T}*A)y=λ₁y, (eq. 2)

where y=(y₁, . . . , yₙ), and y, is centrality value CV of i^{th} user (i=1, . . . n).

In other embodiment, the centrality value (which in this case is similar by its properties and general idea to the Internet Page Rank parameter) for all users can be equated to the eigenvector z corresponding to the eigenvalue 1 in the formula:

N^{T}z=z, (eq. 3)

where z=(z₁, . . . , zₙ), and zᵢ is centrality value CV of i^{th} user (i=1, . . . n); n by n matrix N can be represented as Nᵢⱼ=sLᵢⱼ+(1−s)/n, where 0<s<1 is a parameter of choice, and n by n matrix L could be represented as Lᵢⱼ=0, if during predefined time period there were no financial transactions from user i to user j, otherwise Lᵢⱼ=1/mᵢ, where mᵢ is number of users to whom user i initiated money transfer during predefined time period. In general Lᵢⱼ could be a function of mᵢ and all attributes of financial transactions from user i to other users.

In other embodiments, the centrality value for all users can be defined similar to betweenness centrality, which reflects a topological position of a user within the graph of all users, and which represents total amount of money flow it carries.

In other embodiment, the centrality value for all users can be defined as closeness centrality. In this case a user is considered important if he/she is relatively close to all other actors. Closeness is based on the inverse of the distance of each user to every other user in the network.

The manners of determining centrality values discussed above are merely examples. It will be appreciated that other manners of determining centrality values can also be used. For example, although the description herein of the centrality value of the user is generally based on a degree centrality or its variations, it should be appreciated by one skilled in the art that other centrality values determined by other methods can alternatively be used for optimization of financial transactions flow in a similar fashion.

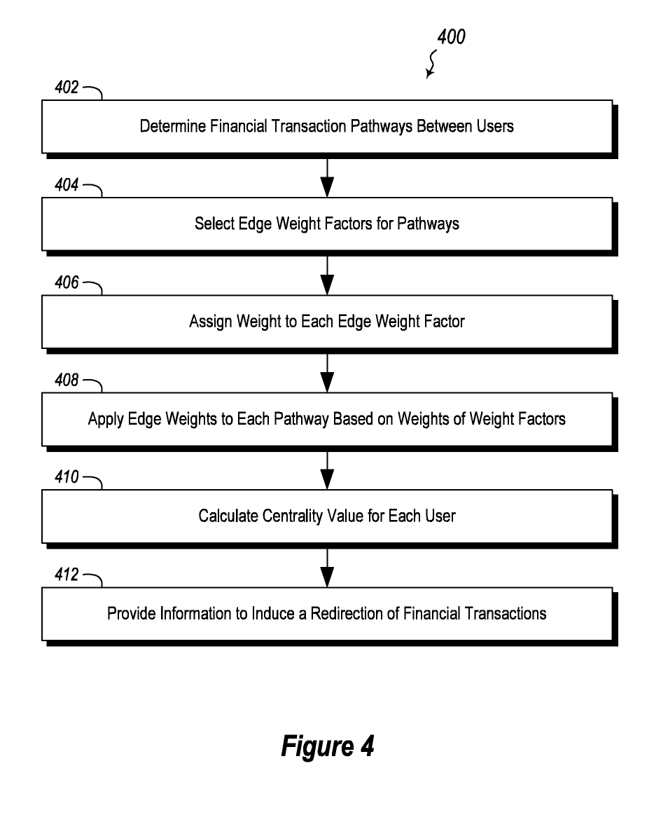

FIG. 5 discloses one method of entering information such as information 210 into a financial transaction network 204 to redirect transactions in the network. As with the discussion above, values from an exemplary financial transactions network 204 will be used. However, the financial transactions network 204 is an example only and is not to be limiting of the methods discussed herein.

In step 501, a financial transactions graph is generated for each user and each financial transaction in a financial transactions network. For example, the graph 300 or the graph 310 may be generated as discussed previously. In one embodiment, for every user (vertex) Xₛ in the set of all users X=(X₁, . . . , Xₖ) (i.e., all users 202) and every edge in the graph, we attach all available attributes where possible. The attributes include, but are not limited to, seller, buyer, category of products, location where transaction happened, time of the day, day of the week, and amount of money user spends/receives on average per category per time period. The attributes may be obtained from user profile information 206, although other sources are also contemplated.

In step 502, a user profile for each user 202 is generated. The user profiles may be based on the attributes attached to each user in step 501.

In step 503, centrality values for each of the users 202 are calculated. The centrality values may be calculated in the manner previously described and may include inward and outward centrality values.

In step 504, a location profile for each user 202 is determined. This determination may be based on physical location information 208 previously described.

In some embodiments, the steps 502-504 may be repeated for each user 202 in the graph 300. For example, the graph 310 may be generated for the users 1-5 based on the financial transactions performed between the users 1-5. A profile may then be generated for each of the users 1-5 and a location of each user may be determined.

In step 505, a determination is made, for every user (vertex) X in the graph that has a non-zero outwards centrality value, of a set of all other users Y=(Y₁, . . . Yₙ) to whom the user under consideration is making payments on regular basis. A profile based on the attributes attached to each user may then be extracted for the user X and other users Y to whom he or she made payment on regular basis. For example, in graph 310, for user 1 the set of all other users Y would include users 2 and 3, for user 2 the set of Y would include users 1, 3, and 4, for user 3 the set of Y would include users 1, 2, and 4, for user 4 the set of Y would include users user 2, and for user 5 the set of Y would include user 2.

In step 506, the centrality values of all users Y who received payments on regular basis from current user X are determined. In some embodiments, the centrality values are calculated in step 503 and in other embodiments the centrality value is calculated in this step. For instance, in the example of graph 310, suppose that user 3 is the current user X. Suppose also that in this example the centrality values used in FIG. 5 are outward centrality values. In that case, the outward centrality values of users 1, 2, and 4 would be determined as these are users that received payments from user 3, presumably on a regular basis.

In step 507, other users Z=(Z₁, . . . , Zₘ) who provide services similar to the services provided by users Y and who are located with a desired proximity of the user X are identified. The desired proximity may be within a range of kilometers or miles that user X would find reasonably close to his or her location. The physical location information 208 may be used in determining the proximity.

To be identified, the profiles of the one or more users Z should at least partially matches the profiles of the users Y who provide similar services. For example, the profiles may indicate that that both the users Y and Z sell a particular type of good or service or that they both deliver in the same general area. In the example of graph 310, suppose that user 5 is identified based on the user profile information 208 as a user Z that provides similar services as one or more of users 1, 2, and 4.

In step 508, the outward centrality value of the one or more users Z identified in step 507 are determined or calculated if they were not determined in previous step. For instance, in the example of graph 310 that outward centrality value of the user 5 is determined or calculated.

In step 509 the outward centrality value of user Z is compared with the outward centrality value of the one or more users Y who provide similar services. If the outward centrality value of the user Z is less than or perhaps equal to the outward centrality value of the users Y, then it is unlikely that redirecting any financial transactions from the users Y to the user Z will have any impact on the financial transactions network 204 and so no action is taken.

However, if the outward centrality value of the user Z is greater than the outward centrality value of at least one user Y, then information such as information 210 may be entered into the financial transaction network 204 to redirect transactions in the network. As discussed above, the information 210 entered into the network may be any type of information that is used to induce the user X to redirect a financial transaction in the network.

In the example of graph 310, the weighted outward centrality value of user 5 is five and the weighted outward centrality value of user 4 is two (see Table 3B). Since five is greater than two, one or more types of information 210 may be entered into the network and provided to user 3 to induce user 3 to redirect his or her financial transactions away from user 4 and towards user 5.

In step 510, it is assumed that the user X has redirected some of his or her future financial transactions to user Z. This is turn leads to the adaptation of a financial transaction network graph G(V,E) which would imply more efficient money or other financial transaction flow within the adapted graph. In other words, the financial transaction network graph G(V,E) is rebuilt to reflect the redirected financial transaction. This should advantageously provide more revenue for the owners of the financial transactions network 204.

In the example of graph 310, the graph 310 may be rebuilt to show that user 3 has redirected his or her financial transactions from user 4 to user 5. The rebuilt graph is shown in FIG. 3C as graph 320. Comparing graphs 310 and 320, it can be seen that the edge arc 314d illustrating the transaction between users 3 and 4 has been redirected to user 5. This is illustrated by dashed edge arc 314g.

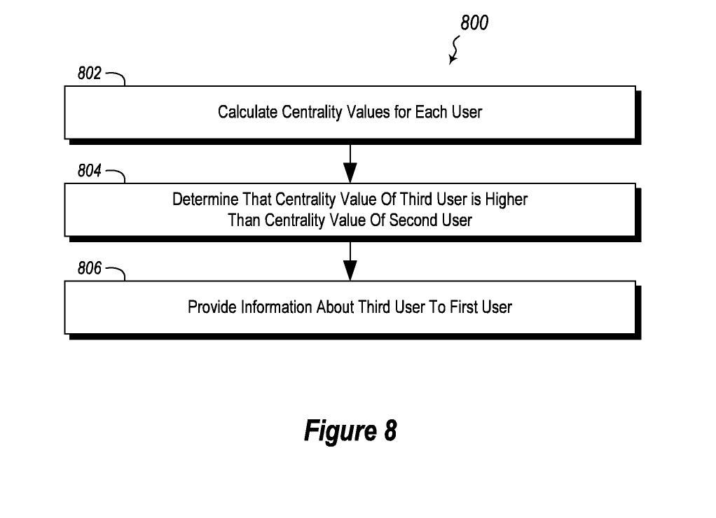

FIG. 8 illustrates a method 800 for identifying a third user who the first user can redirect money flow during a future financial transaction from the second user to the third user. The method 800 may be performed in a mobile financial transaction network such as the financial transaction network 204 where the first user sends money to a second user during a financial transaction.

The method 800 includes a step 802 of calculating a centrality value for at least the first, second, and third users in the mobile financial transaction network. For example, the centrality value for any of the users 202 shown in the financial transactions graphs 300 and 310 may be determined in the manner previously described. The centrality values may include the outwards or inwards centrality values or function of both.

The method 800 includes a step 804 of determining that the third user has a higher centrality value than the second user. For example, the outward centrality values may be compared in the manner previously described.

The method 800 includes a step 806 of providing information to the first user to thereby induce the first user to redirect money flow during a future financial transaction to the third user. For example, the first user may be provided with the information 210. As previously described, the information 210 is intended to induce the first user to redirect at least some of the money flow in the financial transaction network.

In some embodiments, the method 800 may also determine that the third user has characteristics indicating that the third user is able to perform a financial transaction with the first user that is preferable to the financial transaction between the first and second user. For example, as previously described, the characteristics of the user profile information 206 and/or the location information 208 may be used to show that the third user is better able to provide to the first user the same (or at least comparable) goods and services in a preferable manner. The preferable manner may be that the goods and services cost less, are of higher quality, or that the third user is at a closer location or has less costly shipping charges. It will be appreciated, as previously described, that there is no limitation to the characteristics that can be used to determine that the third user is preferable to the second user.

### Mobile Payments

The embodiments disclosed herein may be applied to facilitate mobile payments in a financial transactions network such as those previously discussed. For example, in an embodiment a financial transactions graph such as the graphs 300 or 310 representing mobile payments made between users in a particular time period is generated in the manner previously discussed. In this example financial transaction, weights of the edges of the graph are calculated as a function of total amount of money transferred and number of transactions.

The centrality values corresponding to each user (i.e., vertex or node) are calculated in the manner previously discussed. The relative importance of each user to the mobile payment financial transactions network is determined by using centrality values, inward centrality values and outward centrality values in the manner previously discussed. In general a higher centrality value represents a higher importance of the user within the financial transactions network.

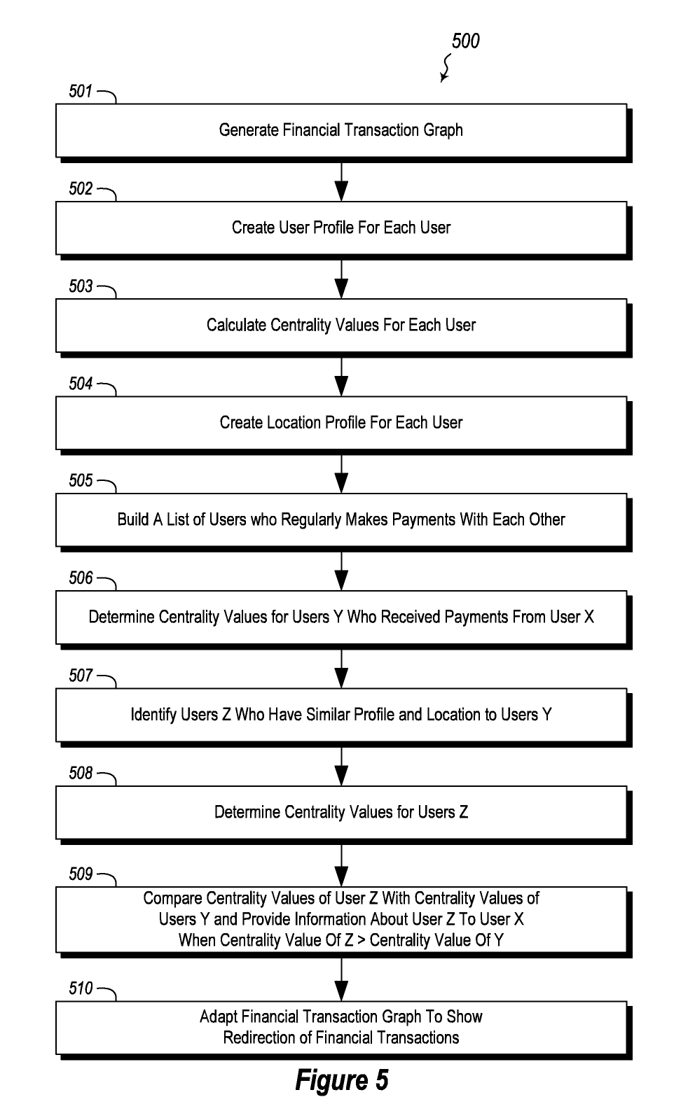

A specific embodiment of mobile payments in a financial transactions network will now be explained. Reference is made to FIG. 6A, which illustrates a financial transaction 600 of a financial transactions network. As illustrated, the financial transactions network includes users 601, 602, 603, and 604. As further illustrated, users 601 and 602 are connected within the graph as indicated at 605 and the user 601 is shown as transferring money to user 602 on a regular basis. In this embodiment, it is assumed that the centrality values, which may correspond to inward and/or outward centrality values, for users 601 and 602 has been computed before, and are 0.9 for user 601 and 0.4 for user 602. It is also assumed that at least partial profile information of users 601 and 602 is available from user profile information 206 in the manner previously described. It is also assumed that profile information and location information are available for the other users, such as users 603 and 604, of the financial transactions network.

In the embodiment, it is determined from the profile information that user 602 is selling groceries, which might be groceries from a grocery store or from local farmer. Based on this information it can be assumed that user 601 is buying groceries on regular basis from user 602. In the embodiment, location information of users 601 and 602 from physical location information 208 is extracted. This may help determine that the physical location of the users in within a certain zip code X.

As described above, the user profile information and the location information of the users 601 and 602 may be used as in one or more filters. For example, a location filter may be used to find all of (or at least one or more) the users within the zip code X. In addition, the user profile information may be used to determine all (or at least one or more) users that sell groceries. It will be appreciated that the filters may be implemented in any reasonable way. In one embodiment, the filters may be computerized filters that allow one or more check boxes to be marked that correspond to the user profile information and the location information of the users 601 and 602.

Applying the filters in the embodiment finds that users 603 and 604 satisfy the conditions of selling groceries within the zip code X as indicated by dashed lines 606 and 607 in FIG. 6B. Accordingly, these two users are potential candidates to redirect the money flow from user 601. The centrality values for users 603 and 604 are then determined in the manner previously described. In the embodiment, the centrality values are 0.1 for user 603 and 0.7 for user 604.

As discussed previously, some of the goals of financial graph adaptation are: a) improving user experience by providing more relevant options/information to the user 601, and b) making sure that money transferred from user 601 to another user of the network as a payment for groceries purchased, will be used later more effectively within the financial transactions network, which may lead to higher revenue for the owners of the financial transactions network and benefit more users within the network. Based on these goals, the owners of the financial transaction network would like to redirect some of the money that user 601 transfers to user 602 to user 604 since user 604 has higher centrality value. As discussed above, a user with a higher centrality value is more likely (or more frequently) to use any received money in a future transactions within the financial network. A higher centrality value of the user may also indicate that other users, connected with the user by the financial transactions graph, are more likely to use any received money in a future transaction within the financial network.

To help induce user 601 to redirect at least some financial transactions to user 604, one or more types of information 210 may be provided to user 601. As discussed above, the information 210 may include some form of advertisement or push notification. In some embodiment, the information 210 may be delivered via SMS or displayed on the screen of a smartphone used by user 601. In the embodiment, the information 210 may inform user 601 that user 604 also sells groceries in zip code X. Further, the information 210 may provide details about the service of user 604 such as cost or the quality of groceries being sold that may improve the experience of user 601 and therefore induce user 601 to continue to use the financial transaction network for further purchases.

In the embodiment, it is assumed that at some time in the future the information 210 will cause the user 601 to at least partially start to buy groceries from user 604 instead of user 602. This redirection of financial transactions from user 602 to user 604 means that the financial transaction 600 has been adapted/modified, as is illustrated in FIG. 6C, where 608 indicates a connection between users 601 and 604. In addition, it may be assumed that user 601 is now having a better user experience, because he or she has made a change in his or her purchasing behavior.

### File Sharing

It will be appreciated that the principles of the embodiments disclosed herein may be applied to networks other than financial transactions networks or to other collections. That is, the graph theory previously discussed and the processes of determining weights, centrality values, may be used to model pairwise relations between objects from a collection other than a financial network previously described.

In one embodiment, the principles of the embodiments disclosed herein may be applied to by a user to locate a file within a network of file providers and perform an operation to obtain the file from a service which is deemed ‘the best’ to provide the file. In this context, the term “file” may apply to an internet style network service, including file-streaming and the transmission of any digital content from one device to another. The connectivity between the users (nodes/devices) can be a mixture of fixed line, wireless including short-range technologies such as Bluetooth.

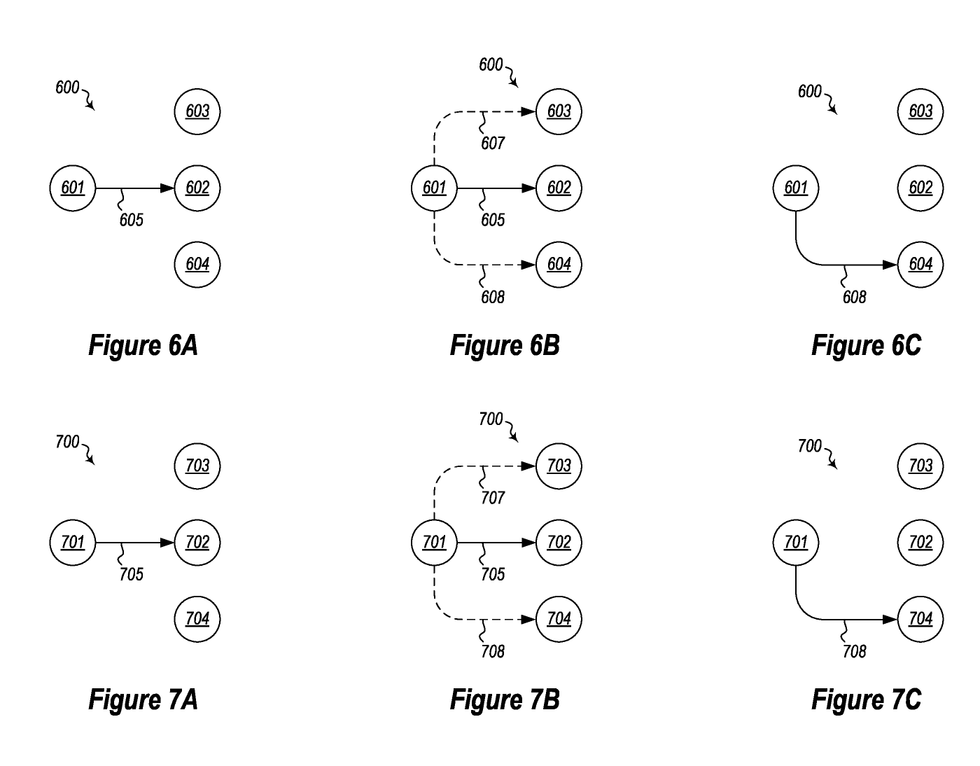

FIG. 7 illustrates a connection graph 700 for a file sharing network. In the connection graph 700, a user 701 usually sends files to a user 702, as indicated by 705. In addition, the graph includes two additional users 703 and 704 who are requesting the same kind of content or file which user 701 sends/shares with the user 702. In the embodiment, the centrality values for all the users are determined in the manner previously described. The edge weighting in this example is calculated as a function of the volume (v) of data transferred, by the speed (s) of the traffic passed from a user (vertex or node) and trust/reputation score (t) of the user. In other words, the edges are weighted with a value determined by v times s times t (v×s×t). The trust/reputation score may be a value that indicates how trustworthy a source is when providing a file. The score may be based upon user feedback such as a “like” in a social media application. It may also be based on requests for a file from other users of the network, where a duplicate request may indicate problems in receiving the file and where no additional requests may indicate successful delivery.

FIG. 7B indicates the centrality values for each of the users in the graph 700. For example, user 701 has a centrality value of 0.9, user 702 has a centrality value of 0.4, user 703 has a centrality value of 0.1, and user 704 has a centrality value of 0.7.

In the embodiment, a filter is applied to determine which users in addition to user 702 desire the file or files provided by user 701. In FIG. 7B, dashed lines 706 and 707 indicate that users 703 and 704 also desire the files.

In this example, a higher centrality value indicates a better candidate for receiving the file or files from user 701. In the embodiment, since user 704 has the highest centrality value, user 704 is determined to be the best candidate to receive the file or files. Accordingly, in order to benefit a file sharing network performance, the file sharing network can automatically provide the file or files from user 701 to the user 704 as this offers the best choice for the network performance in general in terms of speed and trustworthiness. Thus, as illustrated in FIG. 7C, the file sharing network automatically forms a connection 708 of user 701 with the user 704 in the connection graph 700 and can provide the file or files to the user 704.

In some embodiment, the user 701 may provide the file of files, and the system would identify the best destination and immediately action the recommendation to provide the file for the user. One example would be where a developer requires a library of a particular version and the system would identify and obtain that exact file in an automated way that does not require the user 701 to perform any action other than providing the desired files.

In some embodiments, user 702 may be informed by the owners of the file sharing network that it is losing out on serving traffic with user 701, which may affect its brand, revenue via advertising and other means. The system may recommend that user 702 upgrade its network connection and/or file serving behavior so as to raise its trust score. In this way, it may be possible for user 702 to raise its centrality value and perhaps be able to again obtain the file sharing traffic with user 701 or other like users. It will be appreciated that term “informed” in this context may mean any reasonable communication between the owners of the file sharing network and a user.

In addition, user 703 may be informed that it is missing out on service and be given the reasons for its low centrality value. Alternatively, user 703 may approach the owner of the file sharing network and enquire as to their score and missed opportunities.

Accordingly, implementing the embodiments disclosed herein into a files sharing network and like environments may provide for utilizing a faster connection to reduce the time taken to receive the files or files for users of the network. In addition, by obtaining the file or files from the most reliable source, the need for a re-collection attempt and undesired side-affects from obtaining an altered/modified or corrupted file are reduced.

One aspect of the present invention is characterized by a method of redirecting financial transactions between users of a data network adapted to facilitate financial transactions, the method being performed by one or more computer devices, the method comprising: determining financial transaction pathways between terminals associated with users of the data network, the financial transaction pathways being indicative of one or more financial transactions between the users; applying one or more edge weights to each pathway; calculating a centrality value for each user based on the one or more edge weights; and providing information to the terminal of a first user of the data network, the information configured to induce the first user to redirect at least a part of one financial transaction from a second user to a third user, the third user having a higher centrality value than the second user.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method of redirecting financial transactions between users of a financial transactions network, the method being performed by one or more computer devices, the method comprising:
determining financial transaction pathways between users of a financial transactions network, the financial transaction pathways being indicative of one or more financial transactions between the users;
applying one or more edge weights to each pathway;
calculating a centrality value for each user based on the one or more edge weights; and
providing information to a first user of the financial transactions network, the information configured to induce the first user to redirect at least a part of one financial transaction from a second user to a third user, the third user having a higher centrality value than the second user.

2. The method of claim 1, wherein the information provided to the first user comprises one or more of any type of advertisement, a percent off the cost of the future transaction, a push promotion, a recommendation from other users of the financial transactions network, or a description of a good or service.

3. The method of claim 1, wherein the centrality value indicates a number of at least part of financial transactions occurring between the first user and the other users of the financial transactions network.

4. The method of claim 1, wherein the centrality value indicates an amount of electronic funds transferred by at least part of financial transactions occurring between the first user and the other users of the financial transaction network.

5. The method of claim 1, wherein the centrality value is an outward centrality value that indicates the number of at least part of financial transactions that are sent from the first user to the other users of the financial transaction network.

6. The method of claim 1, wherein the centrality value is an outward centrality value that indicates the amount of electronic funds transferred by at least part of financial transactions that are sent from the first user to the other users of the financial transaction network.

7. The method of claim 1, further comprising:
modifying one or more of the financial transaction pathways in response to the first user redirecting the at least part of one financial transaction from the second user to the third user.

8. The method recited in claim 1, further comprising selecting a time period, such that the financial transaction pathways between users are determined only for the selected time period.

9. The method recited in claim 8, wherein the time period comprises a non-contiguous time period.

10. The method of claim 1, further comprising:
applying user profile information to the users of the financial transactions network, the user profile information specifying one or more characteristics about the users and about the financial transactions a user has been involved in;
using the profile information to determine a user profile for each user; and
filtering the user profiles to determine those users with user profiles that have at least one characteristic that matches a characteristic of the first user's user profile, wherein the second and third users are included in the users having at least one characteristic matching the first user.

11. The method of claim 1, further comprising:
applying location information to the users of the financial transactions network, the location information specifying a physical location of the users;
using the location information to determine the physical location of each user;
filtering the user locations to determine those users having a physical location that is within a desired range of the first user's location, wherein the second and third users have a physical location within the desired range.

12. A non-transitory computer readable medium, having stored thereon computer readable instructions that, when executed by a processor of a computing system, cause the computing system to perform a method of redirecting financial transactions between users of a financial transactions network, the method comprising:
determining financial transaction pathways between users of a financial transactions network, the financial transaction pathways being indicative of one or more financial transactions between the users;
applying one or more edge weights to each pathway;
calculating a centrality value for each user based on the one or more edge weights; and
providing information to a first user of the financial transactions network, the information configured to induce the first user to redirect at least part of one financial transaction from a second user to a third user, the third user having a higher centrality value than the second user.

13. The computer readable medium of claim 12, further comprising:
applying user profile information to the users of the financial transaction network, the user profile information specifying one or more characteristics about the users and about the financial transactions a user has been involved in;
using the profile information to determine a user profile for each user; and
filtering the user profiles to determine those users with user profiles that have at least one characteristic that matches a characteristic of the first user's user profile, wherein the second and third users are included in the users having at least one characteristic matching the first user.

14. The computer readable medium of claim 12, further comprising:
applying location information to the users of the financial transaction network, the location information specifying a physical location of the users;
using the location information to determine the physical location of each user;
filtering the user locations to determine those users having a physical location that is within a desired range of the first user's location, wherein the second and third users have a physical location within the desired range.

15. In a mobile financial transactions network that allows a first user to send money to a second user during a financial transaction, a method of identifying a third user to thereby induce the first user to redirect money flow during a future financial transaction from the second user to the third user, the method comprising:
calculating at a processor a centrality value for at least the second and third users in the mobile financial transactions network;
determining that the third user has a higher centrality value than the second user; and
providing information to the first user to thereby induce the first user to redirect money flow during a future financial transaction to the third user.

16. The method of claim 15, further comprising:
determining that the third user has characteristics indicating that the third user is able to perform a financial transaction with the first user that is preferable to the financial transaction between the first and second user.

17. The method of claim 15, wherein the centrality value indicates one of a number of at least part of financial transactions occurring between the first user and the other users of the mobile financial transaction network and the amount of electronic funds transferred by at least part of financial transactions occurring between the first user and the other users of the financial transaction network.

18. The method of claim 15, wherein the centrality value is an outward centrality value that indicates one of a number of at least part of financial transactions that are sent from the first user to the other users of the mobile financial transaction network and the amount of electronic funds transferred by at least part of financial transactions that are sent from the first user to the other users of the financial transaction network.

19. The method of claim 16, wherein the characteristics include information indicating that the third user is able to provide the same service or goods to the first user and that the service or goods are of better quality.

20. The method of claim 16, wherein the characteristics include information indicating that the third user is within a desired location range as the first user.
